(19) United States
(12) Patent Application Publication
(10) Pub. No.: US 2026/0313017 A1
(43) Pub. Date: Oct. 8, 2026

(54) METHOD AND APPARATUS FOR COMMUNICATION BETWEEN APPLICATION CLIENT (AC) AND EDGE ENABLER CLIENT (EEC) IN A WIRELESS COMMUNICATION SYSTEM

(71) Applicant: Samsung Electronics Co., Ltd., Suwon-si, Gyeonggi-do (KR)

(72) Inventors: Basavaraj Jayawant PATTAN, Bangalore (IN); Sapan Pramodkumar SHAH, Bangalore (IN)

(21) Appl. No.: 19/479,087

(22) PCT Filed: May 14, 2024
(86) PCT No.: PCT/KR2024/006602

§ 371 Date: Oct. 27, 2025

(30) Foreign Application Priority Data
May 16, 2023 (IN) 202341034412
Apr. 30, 2024 (IN) 2023 41034412

(51) Int. Cl. H04L 67/10; H04L 61/4511

(52) U.S. Cl. CPC H04L 67/10; H04L 61/4511

(57) ABSTRACT

The disclosure relates to a 5G or 6G communication system for supporting a higher data transmission rate. Embodiments herein provide to method for communication between AC and EEC for ACR. The method includes detecting, by UE (201), whether an Edge Application Server (EAS) is unavailable at a target node during a mobility of the UE. Further, transmitting EEC service notification message from EEC (103) of the UE to the AC (101) of the UE for relocating application context from EAS at the source node to CAS when the EAS is detected to be unavailable at target node. Further, receiving CAS information report message from the AC to the EEC. Further, relocating the application context from the EAS at the source node to the CAS based on the CAS information. Further, transmitting CAS information report acknowledgement message to the AC of the UE indicating successful reception of the CAS information report and successful relocation of the application context.

### TECHNICAL FIELD

Various embodiments of the disclosure relate to edge computing system. More particularly the disclosure relates to communication between application client and edge enabler client for application context relocation in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AT-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In general, an edge computing system is a distributed computing paradigm that brings computations and data storages closer to a geographical location, where the computations and the data storages are needed, to improve response times and save bandwidth. With 5G, data transmission speed increased by multiple times compare to previous generation networks. In order to reduce the latency, the edge computing system is essential to bring computing resources near to end users. In Rel-17, 3GPP has defined Edge Enabler Layer (EEL) in TS 23.558. The EEL exposes APIs to support capabilities such as a service provisioning, a registration, an application server discovery, a capability exposure to AS and support for service continuity. The Application Clients (ACs) in User Equipment (UE) are able to locate and connect with the most suitable Edge Application Server (EAS) available in the Edge Data Network (EDN), using the capabilities provided by the EEL.

As per current 3GPP specification TS 23.558 V18.2.0, there is no interaction specified between the AC and the EEC for enabling Application Context Relocation (ACR) between edge and cloud AS. Without enabling such interactions between AC and EEC, the ACR between edge and cloud application servers cannot be performed.

Thus, it is desired to address the above-mentioned disadvantages or other shortcomings or at least provide a useful alternative.

### DISCLOSURE OF INVENTION

### Solution to Problem

The principal object of the embodiments herein is to enable communication between the AC and the EEC for application context relocation between an edge device and Cloud Application Server (CAS).

Another object of the disclosure is to perform ACR due to unavailability of T-EES (Target-Edge Enabler Server) and T-EAS (Target-Edge Application Server).

Another object of the disclosure is EEC sending trigger to AC, upon which AC performs DNS query to determine CAS information.

Another object of the disclosure is AC sending CAS information to EEC, which is received from AC performing DNS query.

In one aspect, the objectives are achieved by providing a method for communication between AC and EEC for application context relocation. The method includes detecting, by a UE, whether an Edge Application Server (EAS) is unavailable at a target node during a mobility of the UE from a source node to target node. Further, the method includes transmitting, by the UE, an EEC service notification message from the EEC of the UE to the AC of the UE for relocating an application context from the EAS at the source node to a Cloud Application Server (CAS) in response to detecting that the EAS is unavailable at the target node. The EEC service notification message comprises a trigger for DNS query. Further, the method includes receiving, by the UE, a CAS information report message from the AC of the UE to the EEC of the UE. The CAS information report message comprises a CAS information from the AC of the UE as a result of the DNS query. Further, the method includes relocating, by the UE, the application context from the EAS at the source node to the CAS based on the CAS information. Further, the method includes transmitting, by the UE, a CAS information report acknowledgement message to the AC of the UE. The CAS information report acknowledgement message indicates at least one of a successful reception of the CAS information report message and a successful relocation of the application context from the EAS at the source node to the CAS.

In an embodiment, the wherein the CAS information report message is at least one of a DNS trigger status report message and an ACR trigger request message.

In an embodiment, the CAS information report acknowledgement is at least one of a DNS trigger status report acknowledgement message.

In an embodiment, the DNS trigger status report message comprises at least one of a source EAS (S-EAS) information corresponding to the application in AC ID, an indication of whether the DNS query is successful or failure, CAS information, when the DNS query is successful and cause for the failure of the DNS query, when the DNS query is failure.

In an embodiment, the DNS trigger status report acknowledgement message comprises at least one of a S-EAS information corresponding to the application in AC ID, and the indication of the successful reception of the DNS trigger status report message.

In an embodiment, the ACR trigger request message comprises at least one of an AC profile, security credentials of the AC, requested ACR action, S-EAS information, Target-EAS (T-EAS) information, and CAS information.

In an embodiment, the method includes receiving, by the UE, an EEC service notification message at the AC of the UE from an EEC of the UE for relocating application context from the EAS at a source node to a Cloud Application Server (CAS). The EEC service notification message comprises a trigger for DNS query. Further, the method includes performing, by the UE, the DNS query in the AC of the UE to fetch CAS information for relocating the application context from the EAS at a source node to a Cloud Application Server (CAS). Further, the method includes fetching, by the UE, a CAS information at the AC of the UE based on performance of the DNS query. Further, the method includes generating, by the UE, a CAS information report message at the AC of the UE to the EEC of the UE. The CAS information request message comprises at least one of a S-EAS information corresponding to the application of AC ID, an indication of whether the DNS query is successful or failure, the CAS information, when the DNS query is successful and cause for the failure of the DNS query, when the DNS query is failure. Further, the method includes transmitting, by the UE, the CAS information report message to the EEC of the UE. Further, the method includes receiving, by the UE, a CAS information report acknowledgement message from the EEC of the UE. The CAS information report acknowledgement message indicates at least one of the successful reception of the CAS information report message and a successful relocation of the application context from the EAS at the source node to the CAS.

Accordingly, the embodiment herein is to provide a UE for communication between application client (AC) and edge enabler client (EEC) for application context relocation. The UE comprises a processor and a ACR controller coupled to the processor. The ACR controller detects whether an Edge Application Server (EAS) is unavailable at a target node during a mobility of the UE from a source node to target node. Further, the ACR controller transmits an EEC service notification message from the EEC of the UE to the AC of the UE for relocating an application context from the EAS at the source node to a Cloud Application Server (CAS) in response to detecting that the EAS is unavailable at the target node, wherein the EEC service notification message comprises a trigger for DNS query. Further, the ACR controller receives a CAS information report message from the AC of the UE to the EEC of the UE. The CAS information report message comprises a CAS information from the AC of the UE as a result of the DNS query. Further, the ACR controller relocates the application context from the EAS at the source node to the CAS based on the CAS information. Further, the ACR controller transmits a CAS information report acknowledgement message to the AC of the UE. The CAS information report acknowledgement message indicates at least one of a successful reception of the CAS information report message and a successful relocation of the application context from the EAS at the source node to the CAS.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

These and other features, aspects, and advantages of the embodiments are illustrated in the accompanying drawings, throughout which like reference letters indicate corresponding parts in the various figures. The embodiments herein will be better understood from the following description with reference to the drawings, in which:

FIG. 1A is a sequence diagram that illustrates EEC service notification procedure, according to the embodiment as disclosed herein.

FIG. 1B is a sequence diagram that illustrates Domain Name System (DNS) trigger status reporting procedure, according to the embodiment as disclosed herein.

FIG. 2 is a block diagram that illustrates a UE for communication between AC and EEC for application context relocation, according to the embodiment as disclosed herein.

FIG. 3 is a flow diagram that illustrates a method for communication between AC and EEC for ACR, according to the embodiment as disclosed herein.

FIG. 4 illustrates a structure of a user equipment according to the various embodiments disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the disclosure. Furthermore, the elements may have been represented in the drawing by conventional symbols, and the drawings may show only those specific details that are pertinent to the understanding the embodiments of the disclosure so as not to obscure the drawing with details that will be readily apparent to those of ordinary skill in the art having benefit of the description herein.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments disclosed herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Accordingly, the embodiments disclose a method for communication between AC and EEC for application context relocation. The method includes detecting, by a UE, whether an Edge Application Server (EAS) is unavailable at a target node during a mobility of the UE from a source node to target node. Further, the method includes transmitting, by the UE, an EEC service notification message from the EEC of the UE to the AC of the UE for relocating an application context from the EAS at the source node to a Cloud Application Server (CAS) in response to detecting that the EAS is unavailable at the target node. The EEC service notification message comprises a trigger for DNS query. Further, the method includes receiving, by the UE, a CAS information report message from the AC of the UE to the EEC of the UE. The CAS information report message comprises a CAS information from the AC of the UE as a result of the DNS query. Further, the method includes relocating, by the UE, the application context from the EAS at the source node to the CAS based on the CAS information. Further, the method includes transmitting, by the UE, a CAS information report acknowledgement message to the AC of the UE. The CAS information report acknowledgement message indicates at least one of a successful reception of the CAS information report message and a successful relocation of the application context from the EAS at the source node to the CAS.

Accordingly, the embodiments disclose a UE for communication between application client (AC) and edge enabler client (EEC) for application context relocation. The UE comprises a processor and a ACR controller coupled to the processor. The ACR controller detects whether an Edge Application Server (EAS) is unavailable at a target node during a mobility of the UE from a source node to target node. Further, the ACR controller transmits an EEC service notification message from the EEC of the UE to the AC of the UE for relocating an application context from the EAS at the source node to a Cloud Application Server (CAS) in response to detecting that the EAS is unavailable at the target node, wherein the EEC service notification message comprises a trigger for DNS query. Further, the ACR controller receives a CAS information report message from the AC of the UE to the EEC of the UE. The CAS information report message comprises a CAS information from the AC of the UE as a result of the DNS query. Further, the ACR controller relocates the application context from the EAS at the source node to the CAS based on the CAS information. Further, the ACR controller transmits a CAS information report acknowledgement message to the AC of the UE. The CAS information report acknowledgement message indicates at least one of a successful reception of the CAS information report message and a successful relocation of the application context from the EAS at the source node to the CAS.

The proposed solution enables an interaction between AC and EEC for application context relocation between edge and cloud AS. The interaction between the AC and the EEC is enabled when there is no availability of the T-EAS or T-EES. The proposed solution defines a methodology for moving the application context from the EAS of the source node to the CAS, when the T-EES/T-EAS is unavailable at the target node. Hence, the proposed solution ensures locating an accurate reliable cloud application server for a specific application and seamless application communication switching between the edge and the cloud, when the T-EES and T-EAS is unavailable during the handover of UE from source node to target node. Also, the proposed solution ensures continuity of safe and effective working of the UE with cloud network during the handover from source node to target node.

As per existing 3GPP specification TS 23.558 V18.2.0, there is no interaction specified between Application Client (AC) and Edge Enabler Client (EEC) for enabling Application Context Relocation (ACR) between Edge and Cloud Application Servers (AS).

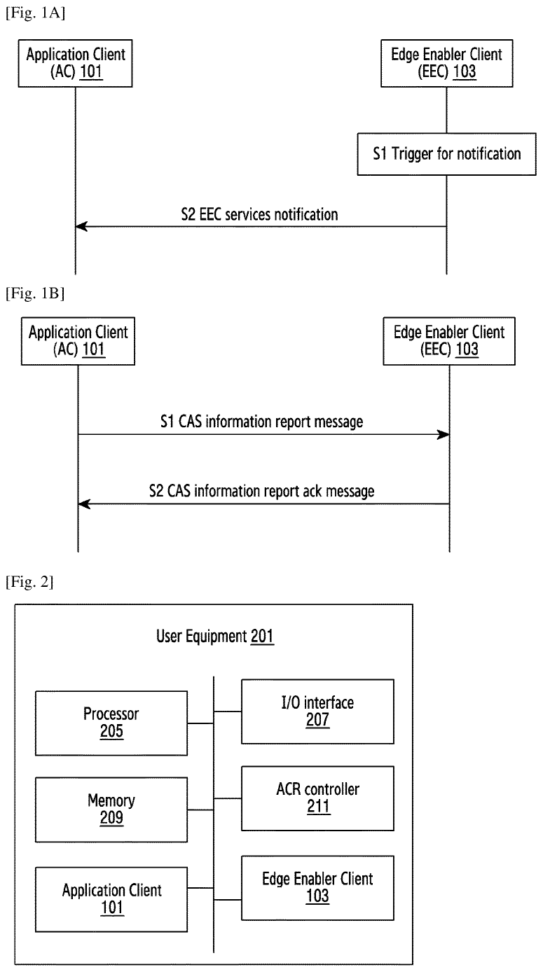

FIG. 1A is a sequence diagram that illustrates EEC service notification procedure, according to the embodiment as disclosed herein.

Consider the AC (101) is subscribed to the EEC (103). At step S1, an event occurs at EEC (103) that satisfies the trigger conditions for notifying the AC (101). For example, the event can be a need for Application Context Relocation, detected by the EEC (103). Upon the even detection, the EEC (103) triggers AC (101) to perform DNS query due to unavailability of suitable T-EES and/or unavailability of suitable T-EAS.

Further, at step S2, the EEC (103) sends an EEC services notification as specified in clause 8.14.2.5.3 of 3GPP TS 23.558 to the AC (101) with relevant information related to the event triggered in step S1. The relevant information can include, but not limited to DNS query.

FIG. 1B is a sequence diagram that illustrates Domain Name System (DNS) trigger status reporting procedure, according to the embodiment as disclosed herein.

The CAS information reporting is performed when the EEC (103) has triggered the AC (101) to perform DNS query due to unavailability of suitable T-EES or T-EAS as specified in clause 8.14.2.5.3 of 3GPP TS 23.558. Further, the at step S1, the AC (101) sends a CAS information report message to the EEC (103), for sharing the result of the EEC (103) requested AC to perform DNS query (due to unavailability of suitable T-EES and/or unavailability of suitable T-EAS). The CAS information message is at least one of a DNS trigger status report message or a ACR trigger request message. Particularly, when the CAS information report message is the DNS trigger status report message, the message includes S-EAS information and the result of DNS trigger status as described in Table 1. The DNS trigger status report includes the information elements as shown in below Table 1:

TABLE 1

| Information | | |
|---|---|---|
| element | Status | Description |
| S-EAS information | M | ID of the EAS to which the DNS trigger |
| | | request relates to. |
| Successful response | O | Indicates that the DNS query was |
| (NOTE) | | successful. |
| > CAS information | O | AC provided target CAS information |
| | | received from DNS query result. |
| Failure response | O | Indicates that the request failed |
| (NOTE) | | |
| > Cause | O | Indicates the cause of request failure |

NOTE:
One of these IEs shall be present in the message.

Further, at step S2, The EEC (103) provides an CAS information report acknowledgement message back to AC (101) as described in Table 2. Particularly, when the CAS information report acknowledgement message is the DNS trigger status report acknowledgement includes information elements as shown in Table 2:

TABLE 2

| Information element | Status | Description |
|---|---|---|
| S-EAS information | M | ID of the EAS to which the DNS trigger |
| | | request relates to. |
| Acknowledgement | M | Indicates receipt of the DNS trigger |
| | | status request. |

In an embodiment, when the CAS information report message is the ACR trigger request message, the information elements included in the ACR trigger request message sent by the AC (101) to the EEC (103) is as shown in below Table 3:

### Enhancements to 8.14.3.10 ACR Trigger Request is Described in Table. 3:

TABLE 3

| Information | | |
|---|---|---|
| element | Status | Description |
| AC profile | M | AC profile for EEC to determine the |
| | | target EAS. |
| Security credentials | M | Security credentials of the AC |
| Requested ACR | M | One of ACR detection or ACR initiation |
| action | | request actions |
| S-EAS information | M | ID of the EAS to which the ACR request |
| | | relates. |
| T-EAS information | O | AC provided target EAS information or |
| (NOTE 1) | | CAS information received from DNS |
| | | query result. |
| CAS information | O | AC provided target CAS information |
| (NOTE 2) | | received from DNS query result. |

NOTE 1:
This IE may be included if the request is to initiate the ACR.
NOTE 2:
This IE may be included if the request is to initiate the ACR and DNS query is performed by AC.

### Enhancements to Table 3: ACR Request

The T-EAS Endpoint is the endpoint information of the CAS, in case of ACR to cloud

### Enhancements to Table 3: ACR Information Notification

The T-EAS information is the CAS information in case of ACR to cloud. In an embodiment, the CAS information can be included in the T-EAS information element as shown in Table. 3. In another embodiment, the CAS information can be included as a separate information element as shown in Table. 3.

FIG. 2 is a block diagram that illustrates an AC or communication with EEC for application context relocation, according to the embodiment as disclosed herein.

The User Equipment (UE) (201) includes a processor (205), a memory (209), an I/O interface (207), a ACR controller (211), the application client (101) and the edge enabler client (103). The UE (201) can be an end-user device that connects with the network apparatus (102) to access services. For example, the UE (201) can include, but not limited to a mobile phone, a smart phone, tablets, laptops, Internet of Things (IoT) devices. Further, the processor (205) of the UE (201) communicates with the memory (209), the I/O interface (207) and the ACR controller (211). The processor (205) is configured to execute instructions stored in the memory (209) and to perform various processes. The processor (205) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (209) of the UE (201) includes storage locations to be addressable through the processor (205). The memory (209) is not limited to a volatile memory and/or a non-volatile memory. Further, the memory (209) can include one or more computer-readable storage media. The memory (209) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (203) of the UE (201) can store several information received in CAS information report message to perform the DNS query and also some information required to be transmitted in the CAS information report acknowledgement message.

The I/O interface (207) transmits the information between the memory (209), application client (101), the edge enabler client (103) and external peripheral devices. The peripheral devices are the input-output devices associated with the UE (201). The I/O interface (207) is responsible for exchange of information between the AC (101) and the EEC (103). The several information can include, but not limited to the EEC service notification, CAS information report message and the CAS information report acknowledgement message.

The ACR controller (211) communicates with the I/O interface (207) and memory (209) for interaction between the AC (101) and the EEC (103). The ACR controller (211) detects whether the EAS is unavailable at the target node during the mobility of the UE (201) from the source node to the target node. When, the unavailability is detected, the ACR controller (211) allows the transmission of the EEC service notification message from the EEC (103) to the AC (101) for relocating an application context from the EAS at the source node to a Cloud Application Server (CAS). The EEC service notification message can include, but not limited to the DNS query. The DNS query is a demand for information (such as IP address) to be transmitted by the UE (201) to the at least one of the EAS or the EES. Particularly, the DNS query is a request made by the UE to a DNS server to resolve a domain name into its corresponding IP address. The AC (101) performs the DNS query. Upon the completion of the DNS query, the ACR controller (211) controls the information flow, while the AC (101) transmits the CAS information report message to the EEC (103). The CAS information report message can include, but not limited to the indication whether the DNS query is successful or failure, the CAS information when the DNS query is successful and the cause for the failure of DNS query when the DNS query is failure. Further, the EEC (103) performs the relocation of the application context from the EAS at the source node to the CAS based on the received CAS information. The application context is a set of data about the AC (101) that resides in the EAS of the source node. Also, the Application context relocation is transferring the application context between the EAS at the source node and the CAS, when the EAS at the target node is unavailable. Further, the EEC (103) transmits the CAS information report acknowledgement message to the AC (101) upon the completion of the application context relocation. The CAS information report acknowledgement message includes, but not limited to the indication of whether the CAS information report message is successfully received and also indicates whether the relocation of the application context is successful.

FIG. 3 is a block diagram that illustrates an EEC for communication with AC for application context relocation, according to the embodiment as disclosed herein.

At an operation 301, the UE (201) detects whether the EAS is unavailable at a target node during a mobility of the UE (201) from the source node to the target node.

At an operation 303, the UE (201) transmits the EEC service notification message from the EEC (103) of the UE (201) to the AC (101) of the UE (201) for relocating an application context from the EAS at the source node to the CAS in response to detecting that the EAS is unavailable at the target node. The EEC service notification message includes the trigger for DNS query.

At an operation 305, the UE (201) receives the CAS information report message from the AC (101) of the UE (201) to the EEC (103) of the UE (201). The CAS information report message includes at least one of the CAS information from the AC (101) of the UE (201) as a result of the DNS query.

At an operation 307, the UE (201) relocates the application context from the EAS at the source node to the CAS based on the CAS information.

At an operation 309, the UE (201) transmits the CAS information report acknowledgement message to the AC (101) of the UE (201). The CAS information report acknowledgement message includes an indication of the at least one of a successful reception of the CAS information report message and the successful relocation of the application context from the EAS at the source node to the CAS.

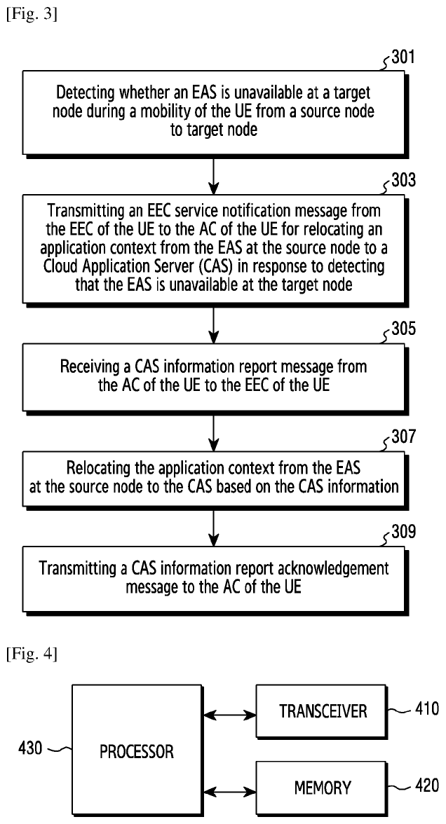

FIG. 4 illustrates a structure of a user equipment according to the various embodiments disclosed herein.

As shown in FIG. 4, the UE according to an embodiment may include a transceiver (410), a memory (420), and a processor (430). The transceiver (410), the memory (420), and the processor (430) of the UE may operate according to a communication method of the UE described above. However, the components of the UE are not limited thereto. For example, the UE may include more or fewer components than those described above. In addition, the processor (430), the transceiver (410), and the memory (420) may be implemented as a single chip. Also, the processor (430) may include at least one processor.

The transceiver (410) collectively refers to a UE receiver and a UE transmitter, and may transmit/receive a signal to/from a base station or a network entity. The signal transmitted or received to or from the base station or a network entity may include control information and data. The transceiver (410) may include a RF transmitter for up-converting and amplifying a frequency of a transmitted signal, and a RF receiver for amplifying low-noise and down-converting a frequency of a received signal. However, this is only an example of the transceiver (410) and components of the transceiver (410) are not limited to the RF transmitter and the RF receiver.

Also, the transceiver (410) may receive and output, to the processor (430), a signal through a wireless channel, and transmit a signal output from the processor (430) through the wireless channel.

The memory (420) may store a program and data required for operations of the UE. Also, the memory (420) may store control information or data included in a signal obtained by the UE. The memory (420) may be a storage medium, such as read-only memory (ROM), random access memory (RAM), a hard disk, a CD-ROM, and a DVD, or a combination of storage media.

The processor (430) may control a series of processes such that the UE operates as described above. For example, the transceiver (410) may receive a data signal including a control signal transmitted by the base station or the network entity, and the processor (430) may determine a result of receiving the control signal and the data signal transmitted by the base station or the network entity.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by an application client (AC) in a wireless communication system, the method comprising:
receiving, from an edge enabler client (EEC), an EEC service notification message for triggering a domain name system (DNS) query based on an unavailability of target edge enabler server (T-EES) or a target edge application server (T-EAS);
transmitting, to the EEC, a DNS trigger status report message; and
receiving, from the EEC, a DNS trigger status report acknowledge message.

2. The method of claim 1,
wherein the DNS trigger status report message includes at least one of source edge application server (S-EAS) information, an indication of whether the DNS query is successful or fails, cloud application server (CAS) information, or a cause for a failure of the DNS query.

3. The method of claim 2,
wherein the DNS trigger status report acknowledges message includes at least one of the S-EAS information, or an indication of a reception of the DNS trigger status report message.

4. The method of claim 1, further comprising:
transmitting, to the EEC, an application context relocation (ACR) trigger request message,
wherein the ACR trigger request message includes at least one of application context (AC) profile, a security credential of the AC, requested ACR action, S-EAS information, or T-EAS information, and
wherein the T-EAS information comprises cloud application server (CAS) information.

5. A method performed by an edge enabler client (EEC) in a wireless communication system, the method comprising:
transmitting, to an application client (AC), an EEC service notification message for triggering a domain name system (DNS) query based on an unavailability of target edge enabler server (T-EES) or a target edge application server (T-EAS);
receiving, from the AC, a DNS trigger status report message; and
transmitting, to the AC, a DNS trigger status report acknowledge message.

6. The method of claim 5,
wherein the DNS trigger status report message includes at least one of source edge application server (S-EAS) information, an indication of whether the DNS query is successful or fails, cloud application server (CAS) information, or a cause for a failure of the DNS query.

7. The method of claim 6,
wherein the DNS trigger status report acknowledges message includes at least one of the S-EAS information, or an indication of a reception of the DNS trigger status report message.

8. The method of claim 5, further comprising:
receiving, from the AC, an application context relocation (ACR) trigger request message,
wherein the ACR trigger request message includes at least one of application context (AC) profile, a security credential of the AC, requested ACR action, S-EAS information, or T-EAS information, and
wherein the T-EAS information comprises cloud application server (CAS) information.

9. An application client (AC) in a wireless communication system, the AC comprising:
a transceiver; and
a controller coupled with the transceiver and configured to:
receive, from an edge enabler client (EEC), an EEC service notification message for triggering a domain name system (DNS) query based on an unavailability of target edge enabler server (T-EES) or a target edge application server (T-EAS);
transmit, to the EEC, a DNS trigger status report message; and
receive, from the EEC, a DNS trigger status report acknowledge message.

10. The AC of claim 9,
wherein the DNS trigger status report message includes at least one of source edge application server (S-EAS) information, an indication of whether the DNS query is successful or fails, cloud application server (CAS) information, or a cause for a failure of the DNS query.

11. The AC of claim 10,
wherein the DNS trigger status report acknowledges message includes at least one of the S-EAS information, or an indication of a reception of the DNS trigger status report message.

12. The AC of claim 9, wherein the controller is further configured to:
transmit, to the EEC, an application context relocation (ACR) trigger request message,
wherein the ACR trigger request message includes at least one of application context (AC) profile, a security credential of the AC, requested ACR action, S-EAS information, or T-EAS information, and
wherein the T-EAS information comprises cloud application server (CAS) information.

13. A edge enabler client (EEC) in a wireless communication system, the EEC comprising:
a transceiver; and
a controller coupled with the transceiver and configured to:
transmit, to an application client (AC), an EEC service notification message for triggering a domain name system (DNS) query based on an unavailability of target edge enabler server (T-EES) or a target edge application server (T-EAS);
receive, from the AC, a DNS trigger status report message; and
transmit, to the AC, a DNS trigger status report acknowledge message.

14. The EEC of claim 13,
wherein the DNS trigger status report message includes at least one of source edge application server (S-EAS) information, an indication of whether the DNS query is successful or fails, cloud application server (CAS) information, or a cause for a failure of the DNS query.

15. The EEC of claim 14,
wherein the DNS trigger status report acknowledges message includes at least one of the S-EAS information, or an indication of a reception of the DNS trigger status report message.
